(19) United States
(12) Patent Application Publication
(10) Pub. No.: US 2024/0298101 A1
(43) Pub. Date: Sep. 5, 2024

(54) WIRELESS EARPIECE WITH SINGLE VENT

(71) Applicant: New Audio LLC, New York, NY (US)

(72) Inventors: Li-Wen Hsieh, ShenZhen (CN); Peng-Fei Yu, ShenZhen (CN); Jonathan Levine, New York, NY (US); Clayton J. Pipkin, Highland Park, NJ (US); Zachary James Coakley-Hellman, New York, NY (US)

(21) Appl. No.: 18/176,887

(22) Filed: Mar. 1, 2023

(51) Int. Cl. H04R 1/10

(52) U.S. Cl. CPC H04R 1/1016; H04R 1/1025; H04R 1/1041; H04R 1/1075; H04R 2420/07; H04R 2460/11

(57) ABSTRACT

A wireless earpiece having no venting port extending from the interior of the earpiece housing to external to the housing on the side of the housing towards the earpiece wearer's ear. The earpiece has a housing defining a front cavity and a back cavity, the front cavity proximate a wearer's ear when the earpiece is positioned in the wearer's ear during use and the back cavity away from the wearer's ear when the earpiece is positioned in the wearer's ear. The earpiece has an audio output nozzle extending from the front cavity configured to extend at least partially within the wearer's ear. In some designs, the earpiece has no vent extending through the housing toward the wearer's ear when the earpiece is positioned in the wearer's ear, but may have a vent extending through the housing away from the wearer's ear when the earpiece is positioned in the wearer's ear.

### BACKGROUND

Wearable audio devices typically include an earpiece configured to be worn in or at a user's ear. The earpiece can include a speaker that converts an audio signal into sound. Because the sound is generated near the user's ear drum, the sound may be fully audible to the user while still being inaudible or minimally audible to others around the user. For this reason, wearable audio devices tend to be well-suited for use in public settings. Some wearable audio devices include one or two ear-supported earpieces. Examples of ear-supported earpieces include earpieces commonly known as earbuds shaped to extend into a user's ear canal and earpieces including hooks shaped to extend over a user's auricle. Other wearable audio devices include one or two head-supported earpieces. Examples of head-supported earpieces include earpieces at opposite respective ends of a headpiece shaped to bridge a user's head. Ear-supported and head-supported earpieces can be wired or wireless. Wired earpieces receive audio content from an audio player via a wire. Wireless earpieces receive audio content from an audio player via Bluetooth or a similar wireless communication standard.

There is always a desire to design a better wearable earpiece having good sound characteristics.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present application relates to wireless earpieces lacking a venting port in the front cavity of the housing of the earpiece. In some embodiments, the venting port is in the back cavity of the housing of the earpiece. Additionally, in some embodiments, there is only one venting port in the housing of the earpiece.

One particular embodiment described herein is a wireless earpiece having a housing defining a front cavity and a back cavity therein, with an audio output nozzle extending from the front cavity, the front cavity having no vent extending from the front cavity through the housing external to the housing.

Another particular embodiment described herein is a wireless earpiece having a housing defining an interior volume comprising a front cavity and a back cavity, the front cavity proximate a wearer's ear when the earpiece is positioned in the wearer's ear during use and the back cavity away from the wearer's ear when the earpiece is positioned in the wearer's ear. The earpiece has an audio output nozzle extending from the front cavity and configured to extend at least partially within the wearer's ear. The earpiece has no vent extending through the housing on the side of the earpiece toward the wearer's ear when the earpiece is positioned in the wearer's ear.

Another particular embodiment described herein is a wireless earpiece having a housing defining a front cavity and a back cavity therein, with an audio output nozzle extending from the front cavity, the housing having only one vent extending through the housing external to the housing.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWING

Non-limiting and non-exhaustive embodiments of the disclosed technology, including the preferred embodiment, are described with reference to the following figures, wherein like reference numerals refer to like parts throughout the various views unless otherwise specified. Many aspects of the present technology can be better understood with reference to the following figures. The components in the drawing are not necessarily to scale. Instead, emphasis is placed on illustrating clearly the principles of the present technology.

FIG. 1A and FIG. 1B are perspective views of an earpiece in accordance with at least some embodiments of the present disclosure.

FIG. 2 is cross-sectional front view of the earpiece, taken along line 2-2 of FIG. 1A.

FIG. 3 is a cross-sectional top view of the earpiece, taken along line 3-3 of FIG. 1A.

FIG. 4 is the cross-sectional top view of FIG. 3 indicating an air flow path within the earpiece.

FIG. 5 is a perspective view of the earpiece with an insert shown removed therefrom and enlarged.

FIG. 6 is a perspective view of the insert from the earpiece with the air flow path through the insert indicated.

FIG. 7 is a graph of passive noise reduction (PNR) comparison for an earpiece of the present disclosure compared to an earpiece having two ports.

FIG. 8 is a graph of frequency response comparison for an earpiece of the present disclosure compared to an earpiece having two ports.

### DETAILED DESCRIPTION

As indicated, the present disclosure is directed to an earpiece lacking a vent port in the front cavity of the earpiece housing. Rather, the earpiece has a vent port located in the back cavity of the earpiece housing, the interior of the front cavity in fluid communication with the back cavity and with the vent port. This vent port can be a bi-directional vent port.

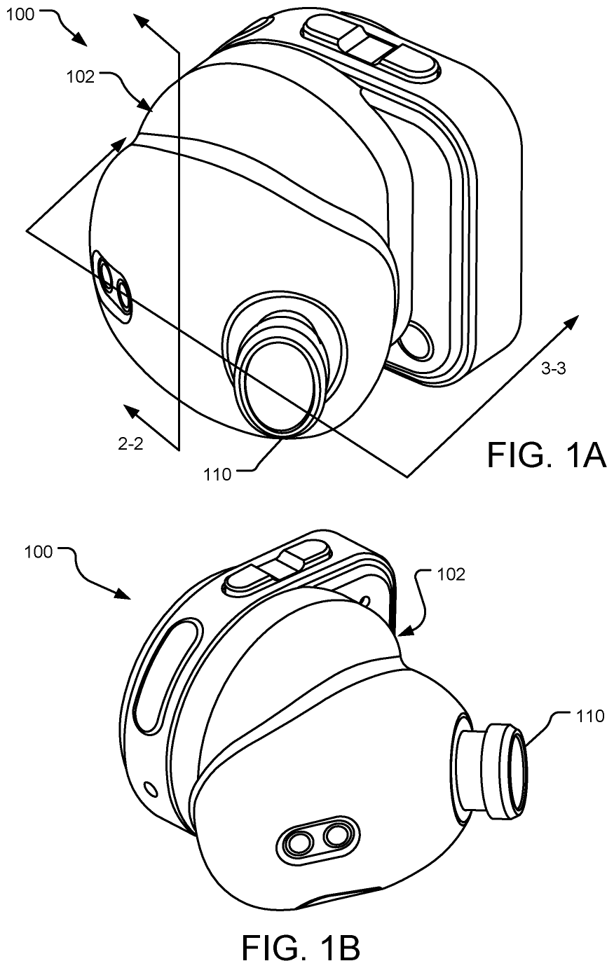

Specific details of wearable audio devices and related devices, systems, and methods in accordance with the present technology are described herein first with reference to FIGS. 1A and 1B through 3. Although wearable audio devices and related devices, systems, and methods may be disclosed herein primarily or entirely in the context of ear-supported earpieces, other types of earpieces are also within the scope of the present technology. For example, suitable features of described ear-supported earpieces can be implemented in the context of head-supported earpieces. Furthermore, it should be understood in general that other devices, systems, and methods in addition to those disclosed herein are within the scope of the present technology. For example, devices, systems, and methods in accordance with embodiments of the present technology can have different and/or additional configurations, components, and operations than those disclosed herein. Moreover, a person of ordinary skill in the art will understand that devices, systems, and methods in accordance with embodiments of the present technology can be without one or more of the configurations, components, and operations disclosed herein without deviating from the present technology.

In the following description, reference is made to the accompanying drawing that forms a part hereof and in which is shown by way of illustration at least one specific embodiment. The following description provides additional specific embodiments. These embodiments are disclosed in sufficient detail to enable those skilled in the art to practice the invention. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

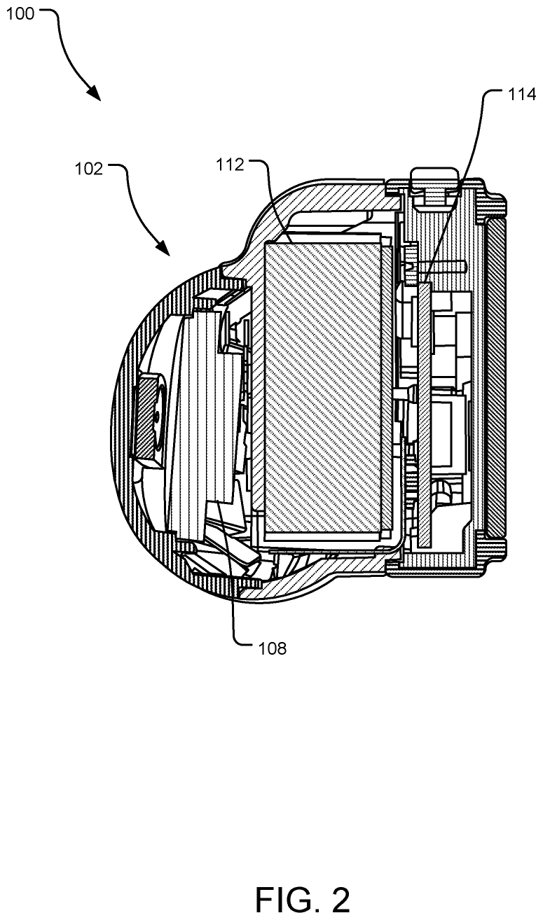

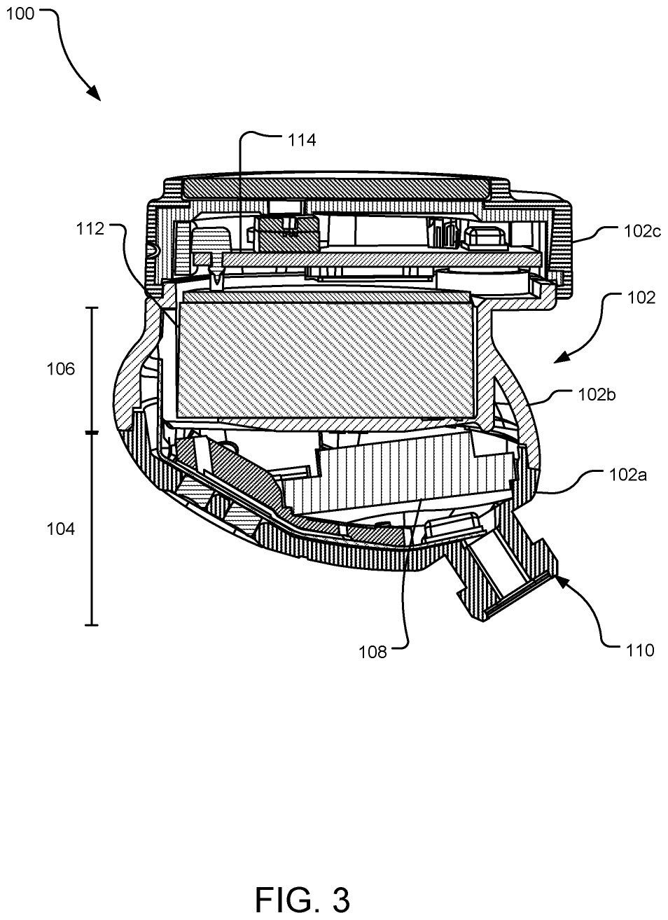

FIGS. 1A and 1B are perspective views of an earpiece 100 in accordance with at least some embodiments of the present technology, and FIGS. 2 and 3 are cross-section interior views of the earpiece 100. The earpiece 100 includes a housing 102 having an exterior surface and an interior surface that defines an interior volume divided as a front cavity 104 and a back cavity 106. When the earpiece 100 is in use, in a wearer's ear, the earpiece 100 is positioned so that the front cavity 104 is proximate the wearer's ear and the back cavity 106 is away from the wearer's ear. In some embodiments, the front cavity 104 is defined by a first housing piece 102a and the second cavity 106 is defined by at least a second housing piece 102b.

In the case of this specific architecture, anything in front of the driver's diaphragm is the front cavity. Everything behind it is the back cavity. The magnet of the driver sits in the back cavity.

Present within the front cavity 104 is the speaker driver 108, which converts electrical signals into sound and commonly includes a magnet, voice coil, and diaphragm. The driver 108 is selected for the desired performance, e.g., tighter frequency response, sound separation, better bass, etc. Present on the exterior surface of the housing 102 and in fluid communication with the front cavity 104 is an audio output nozzle 110 configured (e.g., shaped and sized) to extend from the housing 102 and at least partially fit within the wearer's ear canal. Sound from the earpiece 100 exits the housing 102 via the nozzle 110. The audio output nozzle 110 can include a rigid stem extending outwardly from the housing 102 with a eartip (e.g., removable eartip) formed from a soft, compressible material such as silicone or foam extending circumferentially around the stem. The eartip can be shaped to be snugly received within a canal of the wearer's ear when the earpiece 100 is mounted to the wearer's ear. The audio output nozzle 110 may be integral with the housing 102 or may be formed separate therefrom.

Present within the back cavity 106 is a battery 112 and a printed circuit board assembly (PCBA) 114. The battery 112 and the PCBA 114 may be within a portion of the back cavity 106 defined by a third housing piece 102c, where the second housing piece 102b and the third housing piece 102c define the back cavity 106.

The battery 112 can be operably connected to the driver 108, the PCBA 114 and any suitable processing circuitry needed for operation and functioning of the earpiece 100. In some embodiments, the circuitry is present on or in the PCBA 114 and is configured to receive audio content, e.g., via an antenna over one or more short-range RF bands. The processing circuitry can also be configured to generate sound corresponding to the audio content via the driver 108 within the front cavity 104.

Based on the configuration of earpiece 100 described above and as shown in FIGS. 1A and 1B through 3, the earpiece 100 is generally configured to be worn in a wearer's ear, such as at least partially received within a concha of a wearer's ear and with the audio output nozzle 110 at least partially disposed in the ear canal. As indicated above, when the earpiece 100 is positioned in a wearer's ear, the front cavity 104 faces towards the wearer's head, while the back cavity 106 generally faces away from the wearer's ear and head. In this design of the earpiece 100, a single vent or port 402 is located through the housing 102.

To produce sound for the earpiece's wearer to hear through the nozzle 110, a portion of the driver 108 vibrates, creating sound waves. The moving fluid (e.g., air) within the housing 102 is vented, both for the wearer's comfort and for sound quality, through the vent port 402.

The cavities 104, 106 act as springs in a system and ports or vents control the resonance of the springs. In prior earpieces, a venting port is typically positioned though the housing directly connected to the front cavity to provide a controlled air path to the exterior of the housing. Such a port provides low frequency (bass) response of the earpiece and dramatically reduces passive noise reduction. A second venting port is typically positioned through the housing directly connected to the back cavity; this port provides additional low frequency (bass) response and also reduces the peaks of various resonances in the frequency response. Low frequencies require moving as much air as possible while high frequencies require less air movement.

According to the present design shown, no vent or port is located in the housing 102 proximate to or facing the wearer nor providing a direct path for air from the front cavity 104 to the outside of the earpiece 100; rather, air from the front cavity 104 travels to the back cavity 106 to be vented therefrom. However, simply deleting the venting port from the front cavity of an earpiece as described immediately above would increase the front cavity's spring stiffness to infinity, essentially starving the speaker driver and reducing the acoustic energy output. The present design provides a venting port in the back cavity 106 sufficient to compensate for the air volume from the front cavity 104 while maintaining the flow from the back cavity 106. An internal tortuous air path from the front cavity 104 leads to the back cavity 106 and the venting port; this tortuous air path is tuned to act as a low pass filter. It was found that although the high frequency output for the present design may be less than an earpiece having the direct front cavity venting, the impact on the low frequency output is basically negligible. Thus, the earpiece 100 is lacking a venting port in the front cavity 104. In some embodiments, the earpiece 100 has only one venting port, through the housing 102 proximate the back cavity 106.

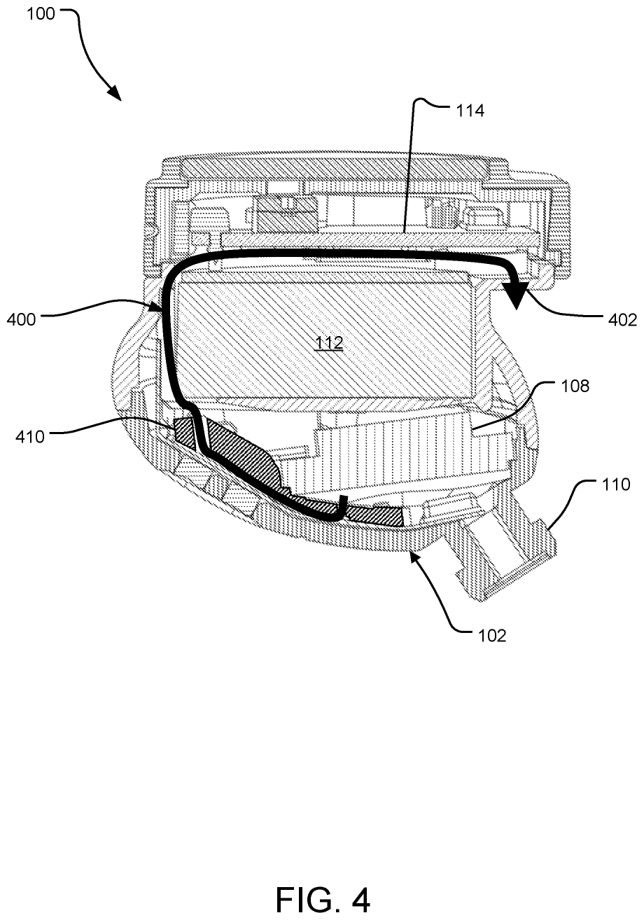

Turning to FIG. 4, an airflow path 400 is shown in the cross-sectional interior view of the earpiece 100, similar to the view of FIG. 3. FIG. 4 shows the housing 102 defining the front cavity 104 and the back cavity 106, with the driver 108 present in the front cavity 104 and the battery 112 and PCBA 114 present in the back cavity 106. Also present in the front cavity 104 is a component 410, further described below. The air path 400 is shown from the front cavity 104 proximate the driver 108, extending through the component 410, past the battery 112 and the PCBA 114, to a venting port 402 in the housing 102.

From the interior volume of the front cavity 104 proximate the driver 108 and the nozzle 110, the air flow path 400 weaves and winds a tortuous path through the component 410, around corners of the battery 112, and through a channel between the battery 112 and the PCBA 114 to the venting port 402. The path 400 can be tuned to specific frequencies. The air flow path 400 is bi-directional, also going from the venting port 402, through the channel between the battery 112 and the PCBA 114, around the battery 112, and through the component 410 to the front cavity 104. Although the view in FIG. 4 shows the path 400 as planar or two-dimensional, it is to be understood that the path 400 may have a third dimension to it. The air flow path 400 has numerous individual turns, some being at or close to 90 degrees, with the overall path 400 extending about 270 degrees from the location proximate the driver 108 to the port 402. Although the airflow path 400 is shown as a line with an exact bi-directional path from a starting point on the front side of the driver 108 (between the driver 108 and the nozzle 110) and passing through the component 410, it is understood that any air present within the volume between the driver 108 and the nozzle 110 may follow the general path 400 and be vented through the port 402. Additionally, air present behind the driver 108 (between the driver 108 and the battery 112) may be vented through the port 402, without passing through the component 410.

In addition to forming a portion of the air flow path 400, the component 410 retains the driver 108 in its position in the front cavity 104. The component 410 includes a notch or detent that receives a corner of the driver 108. The component may be integrally formed with the housing 102 or may be

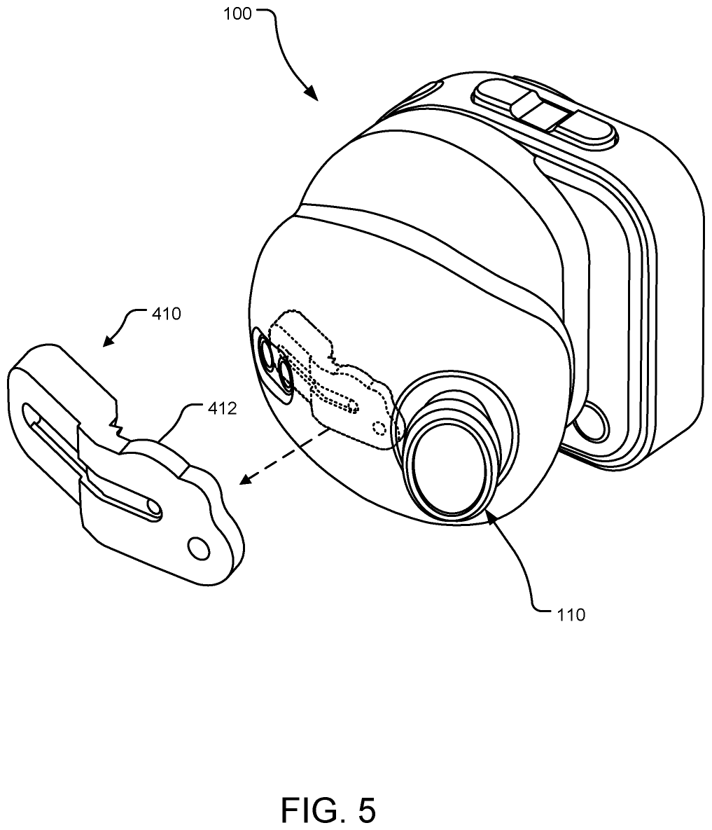

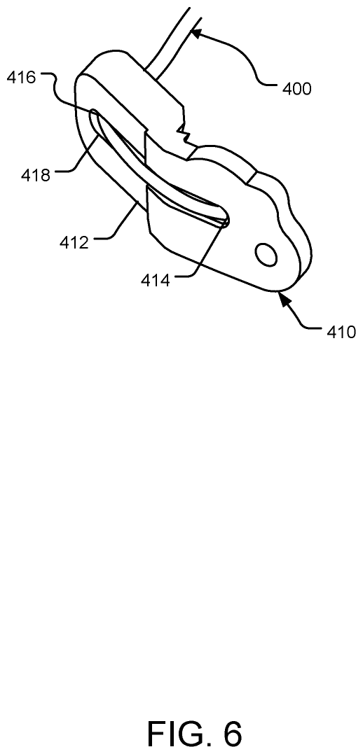

FIG. 5 shows the component 410 in relation to the entire earpiece 100 and FIG. 6 shows the component 410 with the air flow path 400 shown. The component 410 has a body 412 with a first aperture 414 therethrough and a second aperture 416 therethrough. The apertures 414, 416 provide a passage through the component 410 for the air flow path 400 to pass through the component 410, particularly, from a first side of the component 410 to a second side of the component 410, and back to the first side. Also present in the component 410, extending from the first aperture 414 to the second aperture 416, is a channel 418 that forms a portion of the path 400. The channel 418, on the opposite side of the component 410 that holds the driver 108, allows the air path 400 to navigate from the front cavity 104, avoiding the driver 108.

Having the air path 400 through the component 410 allows air from the front cavity 104 to pass to the back cavity 106 rather than venting to outside of the earpiece 100 proximate the front cavity 104 and the wearer (when the earpiece 100 is worn by the wearer). The result is a dramatic improvement in passive noise reduction. Additionally, the port 402 in the back cavity 106 is tuned so that it does not have any significant (negative) impact to the frequency response.

In addition to passive noise reduction, having no vent or port in the housing 102 proximate to or facing the wearer dramatically improves the passive attenuation of the earpiece 100 while still maintaining optimal low frequency output from the speaker driver 108. Additionally, having no direct path from the front cavity 104 to the outside of the earpiece 100. reduces the risk of unwanted dust or water ingress into the front cavity 104 to the driver 108.

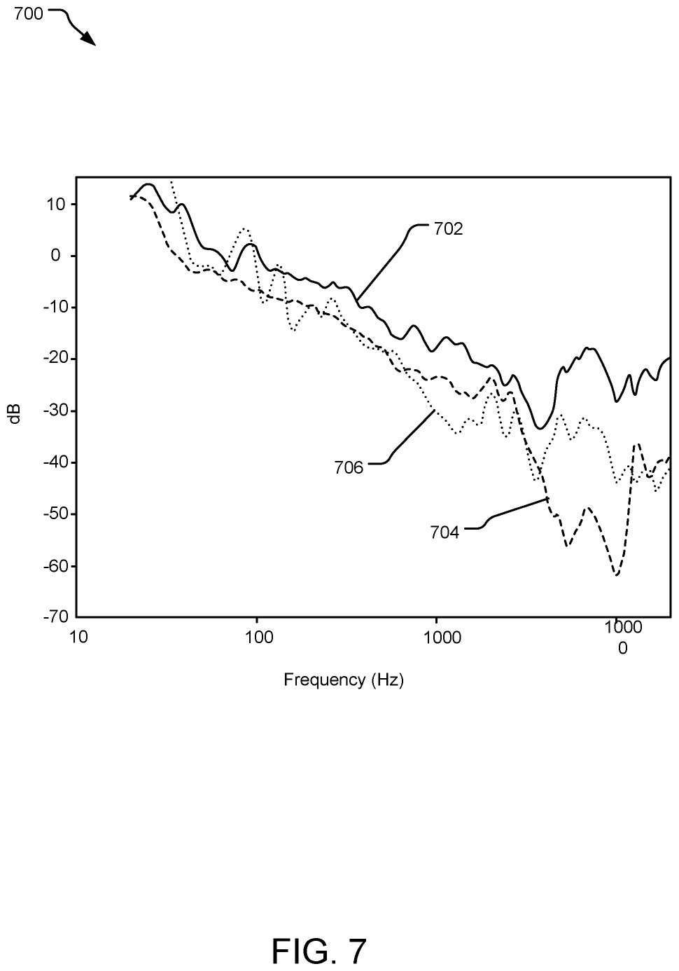

FIG. 7 shows passive noise reduction (PNR) comparison for an earpiece of the present disclosure having no venting port from the front cavity to the outside of the earpiece compared to an earpiece having two ports, one of the ports being from the front cavity.

In FIG. 7, a graph 700 has lines 702, 704, 706. Line 702 represents the noise reduction for an earpiece having two vent ports, one in the front cavity and one in the back cavity, the earpiece commercially available from Master & Dynamic under the trade designation “MW08”. Line 704 represents the noise reduction for an earpiece commercially available from Sony, this earpiece being known as an active noise canceling (ANC) industry leader for wireless earphones. Line 706 represents the noise reduction for an earpiece having one vent port in the back cavity and no venting from the front cavity; the earpiece is in accordance with this disclosure.

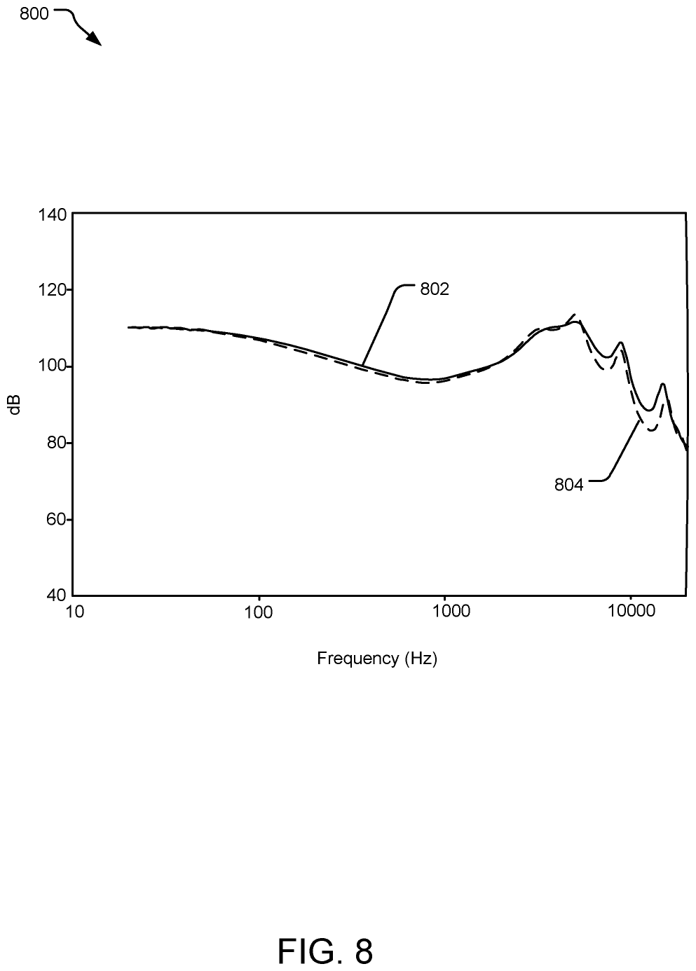

FIG. 8 shows frequency response comparison for an earpiece of the present disclosure compared to an earpiece having two ports.

In FIG. 8, a graph 800 has lines 802 and 804. Line 802 represents the frequency response for an earpiece having two vent ports, one in the front cavity and one in the back cavity, the earpiece commercially available from Master & Dynamic under the trade designation “MW08”. Line 804 represents the frequency response for an earpiece of the present disclosure, having one vent port in the back cavity and no venting from the front cavity. This graph 800 shows that there is minimal difference in frequency response for the earpiece having two vent ports (line 802) and the earpiece having one vent port (line 804).

The present disclosure has generally described a single earpiece 100. However, it should be appreciated that a second earpiece (similar or identical to earpiece 100 though having a mirrored configuration) may be supplied such that the user may place an earpiece in each ears. Such a second earpiece may have some or all of the features of the earpiece 100 described herein. Additionally, the present disclosure has generally described a wireless earpiece 100. However, it should be appreciated that wired earpieces may have the same or similar elements as described herein.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown and/or described in detail to avoid unnecessarily obscuring the description of the embodiments of the present technology. Certain aspects of the present technology disclosed in the context of particular embodiments may be combined or eliminated in other embodiments. Furthermore, while advantages associated with certain embodiments may have been disclosed in the context of those embodiments, other embodiments may also exhibit such advantages, and not all embodiments need necessarily exhibit such advantages or other advantages disclosed herein to fall within the scope of the present technology.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the terms “comprising” and the like, as used throughout this disclosure, mean including at least the recited feature(s) such that any greater number of the same feature(s) and/or one or more additional types of features are not precluded. Directional terms, such as “upper,” “lower,” “front,” “back,” “vertical,” and “horizontal,” may be used herein to express and clarify the relationship between various elements. It should be understood that such terms do not denote absolute orientation. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments of the present technology.

1. A wireless earpiece, comprising:
a housing defining a front cavity and a back cavity therein, with an audio output nozzle extending from the front cavity, the front cavity having no vent extending from the front cavity through the housing external to the housing.

2. The wireless earpiece of claim 1 having a vent extending from the back cavity through the housing.

3. The wireless earpiece of claim 2, further comprising a driver in the front cavity, and a battery and a printed circuit board assembly (PCBA) in the back cavity.

4. The wireless earpiece of claim 3 having an airflow path from the front cavity to the back cavity, around the battery and out from the housing via a vent in the back cavity through the housing.

5. The wireless earpiece of claim 4, wherein the airflow path extends between the battery and the PCBA to the vent in the back cavity.

6. The wireless earpiece of claim 4, wherein the airflow path is a tortuous airflow path.

7. The wireless earpiece of claim 4, further comprising an insert in the front cavity, the insert engaged with the driver and defining a portion of the airflow path.

8. The wireless earpiece of claim 7, wherein the insert includes a channel defining the portion of the airflow path.

9. The wireless earpiece of claim 1, wherein the front cavity is defined by a first housing piece and the second cavity is defined at least partially by a second housing piece.

10. A wireless earpiece, comprising:
a housing defining an interior volume comprising a front cavity and a back cavity, the front cavity proximate a wearer's ear when the earpiece is positioned in the wearer's ear during use and the back cavity away from the wearer's ear when the earpiece is positioned in the wearer's ear;
an audio output nozzle extending from the front cavity and configured to extend at least partially within the wearer's ear;
a vent extending through the housing away from the wearer's ear when the earpiece is positioned in the wearer's ear, and the earpiece having no vent extending through the housing toward the wearer's ear when the earpiece is positioned in the wearer's ear.

11. The wireless earpiece of claim 10 having an airflow path from the front cavity to the back cavity, and out from the housing via a vent in the back cavity through the housing.

12. The wireless earpiece of claim 11, further comprising a driver in the front cavity, and a battery and a printed circuit board assembly (PCBA) in the back cavity, and wherein the airflow path extends between the battery and the PCBA to the vent in the back cavity.

13. The wireless earpiece of claim 12, further comprising an insert in the front cavity, the insert engaged with the driver and defining a portion of the airflow path.

14. The wireless earpiece of claim 13, wherein the insert includes a channel defining the portion of the airflow path.

15. The wireless earpiece of claim 14, wherein the channel is present on a side of insert opposite the driver.

16. The wireless earpiece of claim 11, wherein the airflow path is a tortuous airflow path.

17. A wireless earpiece, comprising:
a housing defining a front cavity and a back cavity therein, with an audio output nozzle extending from the front cavity, the housing having only one vent extending through the housing external to the housing.

18. The earpiece of claim 17, wherein the only one vent extends through the housing from the back cavity.
